(19) United States
(12) Patent Application Publication
(10) Pub. No.: US 2022/0160004 A1
(43) Pub. Date: May 26, 2022

(54) INSTANT CREAM FOR USE IN PASTRIES, CONTAINING ATOMISED PEA STARCH

(71) Applicant: ROQUETTE FRERES, Lestrem (FR)

(72) Inventors: Baptiste BOIT, LA GORGUE (FR); Claude QUETTIER, LAMBERSART (FR)

(21) Appl. No.: 17/594,322

(22) PCT Filed: Apr. 10, 2020
(86) PCT No.: PCT/EP2020/060345

§ 371 Date: Oct. 11, 2021

(30) Foreign Application Priority Data
Apr. 12, 2019 (FR) FR1903953

(51) Int. Cl. A23L 11/00; A23L 9/20

(52) U.S. Cl. CPC A23L 11/05; A23V 2002/00; A23L 9/20

(57) ABSTRACT

The present invention relates to the use of native pea starch precooked by atomisation for the production of creams for pastries.

The present invention relates to a novel pastry cream formulation, in particular an instant formulation, wherein the starch component is entirely substituted with atomized leguminous plant starch, more particularly from peas, to an extent of 15 to 35% by weight, without disrupting the technological and organoleptic properties of said pastry cream.

The present invention thus relates to the use of an atomized leguminous plant starch, more particular from peas, as a partial substitute for the starch component of a pastry cream formulation, to an extent of 20 to 30% by weight.

### FIELD OF THE INVENTION

Synthesized biochemically, a source of carbohydrates, starch is one of the most widespread organic materials in the plant kingdom, where it constitutes organisms' nutrient reserves.

It is thus naturally present in the reserve organs and tissues of higher plants, in particular in cereal grains (wheat, corn, etc.), leguminous plant grains (peas, beans, etc.), potato or cassava tubers, roots, bulbs, stems and fruit.

Starch is a mixture of two homopolymers, amylose and amylopectin, composed of D-glucose units bonded to one another via α-(1-4) and α-(1-6) linkages which are the source of branching in the structure of the molecule.

These two homopolymers differ in terms of the degree of branching thereof, and the degree of polymerization thereof.

Amylose, slightly branched with short branches, and the molecular weight of which may be between 10,000 and 1,000,000 Dalton. The molecule is formed of 600 to 1,000 glucose molecules.

Amylopectin, branched molecule with long branches every 24 to 30 glucose units via α-(1-6) linkages. The molecular weight thereof may range from 1,000,000 to 100,000,000 Dalton, and the degree of branching thereof is approximately 5%. The total chain may be between 10,000 and 100,000 glucose units.

The ratio of amylose to amylopectin depends on the botanical source of the starch.

Starch is stored in reserve organs and tissues in a granular state, i.e. in the form of semi-crystalline granules.

This semi-crystalline state is essentially due to the amylopectin macromolecules.

In the native state, starch grains have a degree of crystallinity which ranges from 15 to 45% and which depends substantially on the botanical origin and on the optional treatment it has undergone.

Granular starch placed under polarized light thus has, in microscopy, a characteristic black cross referred to as “Maltese cross”.

This phenomenon of positive birefringence is due to the semi-crystalline organization of these granules: since the average orientation of the polymer chains is radial.

For a more detailed description of granular starch, reference may be made to chapter II, entitled “Structure et morphologie du grain d'amidon” [“Structure and morphology of the starch grain”] by S. Perez, in the work “Initiation à la chimie et à la physico-chimie macromoléculaires” [“Introduction to macromolecule chemistry and physical chemistry”], first edition, 2000, volume 13, pages 41 to 86, Groupe Français d'Etudes et d'Applications des Polymères [French Polymer Group].

Dry starch contains a water content which ranges from 12 to 20%, depending on the botanical origin. This water content obviously depends on the residual moisture of the medium (for aw=1, the starch may fix up to 0.5 g of water per gram of starch).

Heating, with an excess of water, a starch suspension to temperatures of greater than 50° C. leads to irreversible swelling of the grains and leads to the dispersion thereof, then the dissolution thereof.

It is these properties in particular which give starch its technological properties of interest.

For a given temperature range, referred to as “gelatinization range”, the starch grain will very quickly swell and lose its semi-crystalline structure (loss of birefringence).

All the grains will be as swollen as possible over a temperature range of approximately 5 to 10° C. A paste is obtained which consists of swollen grains which constitute the dispersed phase, and dispersed molecules (mainly amylose) which thicken the aqueous continuous phase.

The rheological properties of the paste depend on the relative proportion of these two phases and on the swelling volume of the grains. The gelatinization range is variable depending on the botanical origin of the starch.

The maximum viscosity is obtained when the starch paste contains a large number of highly swollen grains. When heating is continued, the grains will burst and the material will disperse into the medium, however dissolution will only occur for temperatures of greater than 100° C.

Amylose-lipid complexes have delayed swelling because the combination prevents the interaction of the amylose with the water molecules, and temperatures of greater than 90° C. are necessary in order to obtain the total swelling of the grains (because the amylomaize is complexed to the lipids).

The disappearance of the grains and the dissolution of the macromolecules leads to a reduction in the viscosity.

Lowering the temperature (by cooling) of the starch paste causes insolubilization of the macromolecules and phase separation due to the incompatibility between amylose and amylopectin, then crystallization of these macromolecules is observed.

This phenomenon is known by the name retrogradation.

When a paste contains amylose, it is this first molecule which will undergo retrogradation.

It will consist in the formation of a double helix and the combination of these double helices to form “crystals” (type B) which will give rise to a three-dimensional network via junction zones.

This network is formed very quickly, in a few hours. During the development of this network, the association of the double helices with one another via hydrogen bonds displaces the water molecules associated with the helices and causes significant syneresis.

By virtue of their rheological properties, starches are used in the food industry, not only as a nutritional ingredient but also as a thickener, binder, stabilizer or gelling agent.

For example, native starches are used in preparations requiring cooking. Corn starch, in particular, forms the basis of “powders for flan”. Since it contains amylose, it retrogrades and gels strongly. It makes it possible to obtain firm flans after cooking and cooling.

Native starches are particularly suitable for pastry creams.

Indeed, traditionally, pastry cream is produced by cooking a corn starch (maïzena, or corn flour) or starch (potato starch) in milk in the presence of sugar and eggs.

Starch is then conventionally used for its thickening and gelling function.

As mentioned above, starches are composed of two glucose polymers: amylose and amylopectin. An amylose-rich starch (wheat, corn) gives firm, opaque gels with a short texture. An amylopectin-rich starch (potato) will give a longer gel, with a medium or long texture and which is translucent. Therefore, each source of starch, due to its composition, size, flavor, etc., has different properties.

Corn starch has grains of approximately 5 to 25 micrometers. It provides a cereal flavor. This starch has a gelling temperature of about 75° C. (gelatinization at 70° C.), provides medium viscosity and a rather short texture. It has a high capacity to retrograde. The gel obtained is opaque. This type of starch is used as a gelling agent or thickener in particular in soups, charcuterie, sauces, pasta and creams.

Amylose-rich corn starch gives a short texture once gelled, quick retrogradation times and a high content of resistant starch. It can be used as a processing aid, texturizing agent or source of fiber in bread-making or confectionery with soft gums.

Waxy corn contains virtually exclusively amylopectin. Its starch gives a long and transparent texture. It has a low ability for retrogradation and provides more viscosity than a standard corn starch.

Pea starch has grains of from 5 to 10 micrometers. It has a high amylose content (35%) and a gelling temperature of 72° C. (gelling at 71° C.). It retrogrades and gives a short texture. Its flavor is neutral and the viscosity it produces is low. The film-forming properties of pea starch make it useful in certain coatings. It gives crispness and reduces the fat content in fries and breaded products. In meat, it improves the sliceability of the products. It is used in gelled confectioneries to partially replace gelatin or gum Arabic.

Wheat starch grains measure between 2 and 38 micrometers. Wheat starch is characterized by the highest gelling temperature (85° C.) (gelatinization at 59° C.), a low viscosity and a short texture. The gel is opaque and the flavor thereof is cereal-like. It is used for its properties as gelling agent in numerous applications: pastry cream, short-textured sauce, charcuterie and salting.

The benefit of cassava (or tapioca) is that it has a low amylose content (which makes it quite resistant to retrogradation), and it provides a long, supple and creamy texture after cooking. It has a gelling temperature of 72° C. (gelling at 71° C.). This starch forms a shiny and translucent gel. It is also neutral in terms of flavor and color. Its grains measure between 5 and 35 micrometers. In general, it gives a round and creamy organoleptic profile.

Potato starches provide high viscosity and a relatively neutral flavor. This botanical source also has the largest grains, with a size ranging between 15 and 100 micrometers. The gelling and gelatinization temperature is around 65° C., the lowest temperature compared to the other starches. It gives a long texture and a transparent gel. It also has a high capacity to retrograde.

Rice starch has not only the smallest (3-8 micrometers) but also the whitest starch-based granules. It makes products crispy, crunchy or soft and less liable to shatter. By virtue of their neutral flavor, flavor masking is unnecessary.

However, it is known to the person skilled in the art that, in the native state, starch has limited applications due to
its syneresis,
its low resistance to shear stresses and to heat treatments,
its high retrogradation,
its limited processability, and
its low solubility in common organic solvents.

Thus, in order to meet today's demanding technical requirements, the properties of starch have to be optimized by various methods known as “modification”.

This modification of the starch therefore aims to correct one or more of the abovementioned defects, thereby improving its versatility and meeting the needs of consumers.

Techniques for modifying starch have generally been classified into four categories: physical, chemical, enzymatic and genetic, the ultimate goal being to produce various derivatives with optimized physicochemical properties.

A favored technique for the physical modification of native starch is pregelatinization. This then gives “pregelatinized” or “precooked” starches.

This treatment leads on the one hand to the gelatinization of the starch and on the other hand to the drying thereof, but it leads to fragmentation of the starch grains.

These pregelatinized starches are substantially used as thickeners in products which will not be subject to significant heating. When the starch grains are intact, these starches will disperse under cold conditions.

Reference is also made to “precooked” starch in the sense that pregelatinization consists in “precooking” the starch, i.e. by gelling it, then in dehydrating it once it has gelled.

More particularly, the pregelatinized state of the starch is obtained by cooking granular starch by incorporating water and by supplying thermal and mechanical energy.

The destructuring of the semi-crystalline granular state of the starch leads to amorphous pregelatinized starches with the disappearance of the polarization Maltese cross.

Pregelatinized starches may be obtained by hydrothermal gelatinization treatment of native starches, in particular:
by steam cooking, jet-cooker cooking, drum cooking, cooking in kneader-extruder systems, then
drying, for example in an oven, by hot air over fluidized bed, on a rotary drum, by atomization, by extrusion or by lyophilization.

This operation then makes it possible to use the starch as a gelling agent by diluting it in a cold solution or at ambient temperature.

Such starches generally have a solubility in demineralized water at 20° C. of greater than 5%, and more generally of between 10 and 100%, and a degree of starch crystallinity of less than 15%, generally less than 5%, and commonly less than 1%, or even zero.

The pregelatinized starch is then mainly used in cosmetics or pharmaceuticals, especially when other components of a solution which has to be gelled are sensitive to heat.

In the technical field of the preparation of pastry creams, for concerns of ease of use for consumers, “instant” pastry creams have been developed for reconstitution under cold conditions.

However, it is known to the person skilled in the art that the greatest difficulty is in obtaining instant creams which are as gelled as traditional creams.

There is therefore an unmet need for pastry creams which are mainly due to cooking and which gel quickly.

### SUMMARY OF THE INVENTION

The Applicant company have found that this problem could be solved by choosing a particular mixture of modified potato starch and native leguminous plant starch, more particularly from peas, pregelatinized by atomization.

### DISCLOSURE OF THE INVENTION

A first subject matter of the invention therefore relates to the use of a leguminous plant starch, in particular of a native pea starch, precooked by atomization for the production of pastry creams.

Advantageously, the native leguminous plant starch precooked by atomization is introduced into a pastry cream formula containing a starch component to substitute 15 to 35% by weight, preferably 20 to 30% by weight, of said starch component. The starch component may in particular be waxy corn starch or potato starch, preferably precooked phosphate-cross-linked and acetate-stabilized potato starch.

A second subject matter of the invention relates to a pastry cream composition containing a starch component comprising the native leguminous plant starch precooked by atomization and at least one starch other than a leguminous plant starch.

Advantageously, 15 to 35% by weight, preferably 20 to 30% by weight of the starch component consists of the native leguminous plant starch precooked by atomization. The starch other than a leguminous plant starch may in particular be waxy corn starch or potato starch, preferably precooked phosphate-cross-linked and acetate-stabilized potato starch.

Finally, a third subject matter of the invention relates to a method for preparing a pastry cream comprising a starch component, characterized in that 15 to 35% by weight, preferably 20 to 30% by weight of the starch component of the pastry cream formula is substituted with native leguminous plant starch precooked by atomization. The starch component of the pastry cream may in particular be waxy corn starch or potato starch, preferably precooked phosphate-cross-linked and acetate-stabilized potato starch.

### DETAILED DESCRIPTION

For the purposes of the present invention, “leguminous plant” means any plant belonging to the families of the cesalpiniaceae, mimosaceae or papilionaceae, and particularly any plant belonging to the family of the papilionaceae, for example pea, bean, broad bean, field bean, lentil, alfalfa, clover or lupin.

This definition includes in particular all the plants described in any one of the tables contained in the article by R. HOOVER et al. entitled “Composition, structure, functionality and chemical modification of legume starches: a review” (Can. J. Physiol. Pharmacol. 1991, 69 pp. 79-92).

Preferably, the leguminous plant is selected from the group comprising pea, bean, broad bean and field bean.

Advantageously, it is pea, the term “pea” being considered here in its broadest sense and including in particular:

all the wild-type varieties of “smooth pea”, and

all the mutant varieties of “smooth pea” and of “wrinkled pea”, regardless of the uses for which said varieties are usually intended (human food, animal feed and/or other uses).

Said mutant varieties are in particular those named “mutants r”, “mutants rb”, “mutants rug 3”, “mutants rug 4”, “mutants rug 5” and “mutants lam” as described in the article by C-L HEYDLEY et al., entitled “Developing novel pea starches,” Proceedings of the Symposium of the Industrial Biochemistry and Biotechnology Group of the Biochemical Society, 1996, pp. 77-87.

According to another advantageous variant, the leguminous plant is a plant, for example a variety of pea or field bean, giving grains containing at least 25%, preferably at least 40%, by weight of starch (dry/dry).

“Leguminous plant starch” is intended to mean any composition extracted, by any means, from a leguminous plant and in particular from a papilionaceae, the starch content of which is greater than 40%, preferably greater than 50% and even more preferentially greater than 75%, these percentages being expressed as dry weight relative to the dry weight of said composition.

Advantageously, this starch content is greater than 90% (dry/dry). It may in particular be greater than 95%, including greater than 98%.

For the purposes of the invention, “atomized” leguminous plant starch means a leguminous plant starch cooked by atomization. The droplets fall into a stream of pressurized hot air which precooks and instantly dries the granules. The hot air is conveyed at different pressures (between 14 and 24 bar). The atomization is multi-effect, with the fines being recycled at the top of the tower. An agglomerated powder is then obtained.

“Native” starch means a starch which has not undergone any chemical modification.

A pastry cream for the purposes of the invention comprises a starch component. Generally, a conventional pastry cream formula also comprises sugar, milk and eggs and optionally flavorings such as vanilla. There are also instant preparations making it possible to prepare a pastry cream from a mixture in powder form containing a starch component and generally sugar, milk proteins and/or milk powder, stabilizing agents and thickeners, and optionally flavorings. Conventionally, the starch component of pastry creams is native potato starch. The Applicant company very early on proposed substituting these with chemically stabilized starch.

By way of example, mention may be made of the products manufactured and sold by the Applicant under the brand name PREGEFLO®, cold-soluble starches obtained from native or chemically modified starch by pregelatinization.

As a texturizing solution in pastry creams, the Applicant company recommends using PREGEFLO® PJ 20, a precooked phosphate-cross-linked and acetate-stabilized potato starch (E1414).

However, this solution is not entirely satisfactory.

Moreover, since the use of chemically modified starches is not appreciated by the consumer, it was of benefit to find an alternative by total or partial substitution of said chemically modified starches in the ingredients of pastry creams.

Finally, another aim is to improve instant pastry creams by providing a more gelled and cuttable appearance after several hours at +4° C.

The Applicant company chose to test a certain number of starches, taken alone or in combination, so as to develop the best formula:

as control: PREGEFLO® PJ 20;

native potato starch dried by atomization in hot air at 18 bar (hereinafter ATOMIZED STARCH 18 bar);

cross-linked/phosphate-stabilized/hydroxypropyl potato starch, sold by the Applicant company under the brand name CLEARAM® PR 05 10, precooked by atomization in hot air at 24 bar (hereinafter ATOMIZED PR 05 10 24 bar);

precooked pea starch atomized under hot air at 16 bar (hereinafter ATOMIZED PEA STARCH 16 bar);

precooked pea starch atomized under hot air at 18 bar (hereinafter ATOMIZED PEA STARCH 18 bar);

two commercially available products offered for this application, sold by AVEBE:

ELIANE™ BC

PASELLI™ BC

The different prototypes were tested alone in the application, then mixtures were produced (in particular mixtures in which 10, 20, 30, 40 and 50% of PREGEFLO® PJ 20 was substituted with ATOMIZED PEA STARCH 16 bar or 18 bar).

Analyses are carried out to assess the quality of the pastry creams produced:

Macroscopic observations (panel consisting of experimenters from the application laboratory),

Viscosity test on Brookfield rheometer (following manufacturer's specifications for gelled products (Helipath spindle no. 94—shear stress of 5 rpm)

Beating test (consisting in whipping the cream for 3 minutes in a Hobart mixer equipped with a whisk—the ability of the cream to re-gel after beating is determined).

The pastry cream formula is as follows:

50 g of starch,

140 g of starch-free pastry cream sold by CSM (mixture for instant pastry creams, containing sugar, milk powder, milk proteins, flavorings and carrageenans),

500 g of water

The procedure is as follows:

mix the powders in order to obtain a homogeneous mix

hydrate the powders with water, by manually mixing so as to prevent clumps

mix in the Hobart mixer for 3 minutes at speed 3 to obtain a smooth cream.

As will be demonstrated in the examples below:

very good results were obtained for texture and elasticity with mixtures of PREGEFLO® PJ 20 and ATOMIZED PEA STARCH 16 bar or 18 bar in a 70/30 proportion;

Brookfield viscosity measurements show that the stability of the creams is preserved over time (up to 24 h of storage at +4° C.) for mixtures of PREGEFLO® PJ 20 and ATOMIZED PEA STARCH 16 bar or 18 bar in a 70/30 proportion and also in an 80/20 proportion;

the beating tests show that the mixtures of PREGEFLO® PJ 20 and ATOMIZED PEA STARCH 16 bar or 18 bar in a 70/30 proportion have the ability to re-gel;

It is therefore possible to substitute from 15 to 35% by weight, preferably 20 to 30% by weight of chemically stabilized pregelatinized modified starch with pea starch precooked by atomization without disrupting the technological qualities of the instant pastry creams.

The invention will be better understood on reading the following examples, which are intended to be illustrative, only mentioning certain embodiments and certain advantageous properties according to the invention, and are non-limiting.

### BRIEF DESCRIPTION OF THE DRAWINGS

Other features, details and advantages will appear from reading the following detailed description, and by analyzing the appended drawings in which:

FIG. 1 shows the Brookfield viscosity in mPa·s between 0 and 24 h for different pastry creams analyzed in example 2.

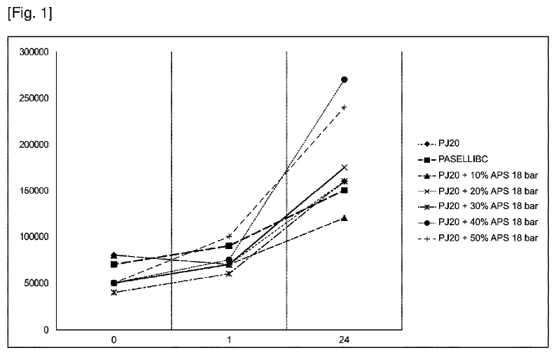

### EXAMPLES

### Example 1: Preparation of the Pea Starches Precooked by Atomization

The pea starches are precooked by atomization in a multi-effect atomizer tower (of MSD or NIRO type) with the fines being recycled in the vibrating fluidized bed fitted with a single steam cooking nozzle, the product obtained is then sieved to eliminate any agglomerates.

An equivalent procedure is carried out for the products based on native potato starch (to obtain the control ATOMIZED STARCH 18 bar) or based on cross-linked/phosphate-stabilized/hydroxypropyl potato starch, sold by the Applicant company under the brand name CLEARAM® PR 05 10 (to obtain the control PR 05 10 ATOMIZED 24 bar).

The details of the parameters are presented in the following table for the production of the ATOMIZED PEA STARCH 16 bar and 18 bar:

TABLE 1

| | |
|---|---|
| | ATOMIZED |
| | PEA |
| ATOMIZED PEA | STARCH |
| STARCH 16 bar | 18 bar |

Preparation of the pea starch milk

| | | |
|---|---|---|
| Starch milk (% solids) | 30 | 30 |
| Temperature of the starch milk (° C.) | 20 | 20 |

Operating parameters of the atomizer

| | | |
|---|---|---|
| Spraying system SK nozzle | 46*28 | 46*28 |
| Vapor pressure (bar) | 16 | 18 |
| Vapor flow rate (kg/h) | 148 | 165 |
| Atomization pressure (bar) | 117 | 115 |
| Starch milk flow rate (kg/h) | 940 | 940 |
| Upstream air flow rate (Nm3/h) | 18,000 | 18,000 |
| Upstream air temperature (° C.) | 155 | 155 |
| Static bed air flow rate (Nm3/h) | 6000 | 65 |
| Static bed air temperature (° C.) | 90 | 90 |
| Air temperature tower outlet (° C.) | 72 | 75 |
| Vibrating fluidized bed air flow rate | 5500 | 5500 |
| (Nm3/h) | | |
| Vibrating fluidized bed air | 15 | 15 |
| temperature (° C.) | | |
| Outlet of the atomizer tower | 600 μm | 600 μm |
| Sieving | | |

### Example 2: Analyses of the Pastry Creams Produced

First pastry creams are produced with the starch without mixing.

Macroscopic observations made at t0 and at t_{24 h} at 4° C.

At t0

TABLE 2

| Reference | Starch | Visual characteristics |
|---|---|---|
| A | PASELLI ™ BC | Short texture |
| B | PREGEFLO ® PJ20 | Short texture |
| C | ATOMIZED STARCH 18 bar | Long, very elastic texture |
| D | PR 50 10 ATOMIZED 24 bar | Long, elastic texture |
| E | ATOMIZED PEA STARCH 18 bar | Long, very elastic texture |

At t_{24 h} at 4° C.

TABLE 3

| Reference | Starch | Visual characteristics |
|---|---|---|
| A | PASELLI ™ BC | Gelled, melt-in-the-mouth |
| | | texture |
| B | PREGEFLO ® PJ20 | Gelled, melt-in-the-mouth |
| | | texture |
| C | ATOMIZED STARCH 18 bar | Very long, very elastic texture, |
| | | not very gelled |
| D | PR 50 10 ATOMIZED 24 bar | Quite thin, long, elastic texture |
| E | ATOMIZED PEA STARCH | Brittle gel, highly gelled, not |
| | 18 bar | melt-in-the-mouth |

PREGEFLO ® PJ 20 gives a slightly less gelled pastry cream than PASELLI ™ BC.
ATOMIZED STARCH 18 bar gives relatively unsuitable results, with a long and elastic texture and no retrogradation after 24 h.

After storing overnight, the ATOMIZED PEA STARCH 18 bar gels too strongly.

By virtue of these first results, it seemed beneficial to test the incorporation of pea in the standard solution PREGEFLO® PJ20 to improve the texture of the pastry cream.

Mixtures were thus made with PREGEFLO® PJ20 and the ATOMIZED PEA STARCH 16 and 18 bar, with 10 mixtures being made containing 10, 20, 30, 40, and 50% weight/weight of substitution of PREGEFLO® PJ20 with the ATOMIZED PEA STARCH (16 and 18 bar).

Macroscopic observations at t0 and at t_{24 h} at 4° C.

The observation scale is as follows:

“−” lack of elasticity or gelling
“++++”: for elasticity: optimal performance; for gelling: too high, brittle gel
“+”, “++”, “+++” reflect intermediate amplitudes.

TABLE 4

| | Elasticity at | Gelling at t_{24 h} at |
|---|---|---|
| Substitution of PREGEFLO ® PJ 20 | t0 | +4° C. |
| 10% ATOMIZED PEA STARCH 16 bar | − | + |
| 20% ATOMIZED PEA STARCH 16 bar | − | ++ |
| 30% ATOMIZED PEA STARCH 16 bar | + | +++ |
| 40% ATOMIZED PEA STARCH 16 bar | ++ | ++++ |
| 50% ATOMIZED PEA STARCH 16 bar | +++ | ++++ |
| 10% ATOMIZED PEA STARCH 18 bar | − | + |
| 20% ATOMIZED PEA STARCH 18 bar | + | ++ |
| 30% ATOMIZED PEA STARCH 18 bar | ++ | +++ |
| 40% ATOMIZED PEA STARCH 18 bar | +++ | ++++ |
| 50% ATOMIZED PEA STARCH 18 bar | ++++ | ++++ |

A very good gelled texture of pastry cream appears with the mixture of PREGEFLO® PJ20+30% ATOMIZED PEA STARCH 16 and 18 bar. Moreover, the elasticity of these creams containing 30% pea starch is acceptable.

For greater percentages of pea, the gelling is too great and the elasticity becomes unacceptable.

Substituting part of the PREGFLO® PJ20 with ATOMIZED PEA STARCH therefore does indeed appear to correct the flaws of the pastry cream produced with PREGEFLO PJ20 alone.

These macroscopic observations will be validated with Brookfield viscosity measurements.

First viscosity measurements are taken at t_{24 h} at +4° C. on pastry creams prepared with different starches without mixing.

The values obtained for the ATOMIZED PEA STARCH 16 bar or 18 bar, PREGEFLO® and PASELLI™ BC are thus compared.

The values measures are:

ATOMIZED PEA STARCH 18 bar: 900,000 mPa·s

ATOMIZED PEA STARCH 16 bar: 600,000 mPa·s

PREGEFLO® PJ20: 160,000 mPa·s

PASELLI™ BC: 150,000 mPa·s.

This thus gives the behavior observed for pastry creams when a single type of starch is used as ingredient.

The measurements were then taken on pastry creams prepared with a mixture of PREGEFLO® PJ20 and ATOMIZED PEA STARCH 16 bar or 18 bar.

After 24 h of storage, it is observed that the mixtures with 20 and 30% ATOMIZED PEA STARCH 18 bar give pastry creams having viscosities which are virtually the same and close to that of PASELLI™ BC.

Whereas the substitution at 40 and 50% leads to viscosities which are much too high. At 10% incorporation, the viscosity is lower than that of PREGEFLO® PJ 20, which is not the desired effect.

For the ATOMIZED PEA STARCH 16 bar, the viscosities after 24 h are all the same, except for the mixture containing 50%, for which the viscosity is higher.

Comparing the mixtures with ATOMIZED PEA STARCH 18 bar at 20 and 30% substitution and the mixture with ATOMIZED PEA STARCH 16 bar at 30% substitution, similar viscosities are observed.

The textures are gelled but remain melt-in-the-mouth.

The most suitable mixtures are therefore indeed:

PJ20+20% ATOMIZED PEA STARCH 18 bar

PJ20+30% ATOMIZED PEA STARCH 18 bar

PJ20+30% ATOMIZED PEA STARCH 16 bar

Very good properties are observed under cold conditions for these mixtures.

As for the beating tests, they demonstrate the good behavior of the pastry creams prepared with the mixtures.

1-11. (canceled)

12. A use of a leguminous plant starch, in particular of a native pea starch, precooked by atomization for the production of pastry creams.

13. The use according to claim 12, wherein the native leguminous plant starch precooked by atomization is introduced into a pastry cream formula containing a starch component to substitute 15 to 35% by weight, preferably 20 to 30% by weight, of said starch component.

14. The use according to claim 13, wherein the starch component is waxy corn starch or potato starch.

15. The use according to claim 14, wherein the potato starch component is precooked phosphate-cross-linked and acetate-stabilized potato starch.

16. A pastry cream composition containing a starch component comprising the native leguminous plant starch precooked by atomization and at least one starch other than a leguminous plant starch.

17. The composition according to claim 16, wherein 15 to 35% by weight, preferably 20 to 30% by weight of the starch component consists of the native leguminous plant starch precooked by atomization.

18. The composition according to claim 17, wherein the starch other than a leguminous plant starch is waxy corn starch or potato starch.

19. The composition according to claim 18, wherein the substituted potato starch is phosphate-cross-linked and acetate-stabilized potato starch.

20. A method for preparing a pastry cream comprising a starch component, wherein 15 to 35% by weight, preferably 20 to 30% by weight of the starch component of the pastry cream formula is substituted with native leguminous plant starch precooked by atomization.

21. The method according to claim 20, wherein the starch component of the pastry cream is waxy corn starch or potato starch.

22. The method according to claim 21, wherein the potato starch is phosphate-cross-linked and acetate-stabilized potato starch.
